(19) United States
(12) Patent Application Publication
(10) Pub. No.: US 2016/0193645 A1
(43) Pub. Date: Jul. 7, 2016

(54) CERAMIC REFRACTORY INSULATION BLOCK INCLUDING REINFORCING RODS

(71) Applicant: The Boeing Company, Chicago, IL (US)

(72) Inventors: Daniel G. Sanders, Cle Elum, WA (US); Larry D. Hefti, Auburn, WA (US); Mark T. Schergen, Seattle, WA (US); James Philp, Tacoma, WA (US); Peter N. Comley, Sumner, WA (US)

(21) Appl. No.: 14/590,554

(22) Filed: Jan. 6, 2015

(51) Int. Cl. B21D 22/02; C04B 35/71

(52) U.S. Cl. CPC B21D 22/022; C04B 35/71

(57) ABSTRACT

A ceramic refractory insulation block for a hot press is provided that is reinforced in a manner that reduces the likelihood of cracking and, once cracked, reduces the rate at which the crack will propagate through the ceramic refractory insulation block. The ceramic refractory insulation block includes a ceramic body defining a plurality of outer surfaces. Each of the surfaces is a planar surface. The ceramic body also defines a centerline about which the ceramic body is subjected to a bending moment. The ceramic refractory insulation body also includes a plurality of reinforcing rods extending through the ceramic body. The reinforcing rods have a greater flexural strength than the ceramic body. One or more of the plurality of reinforcing rods extend through the ceramic body on each of the opposed sides of the centerline about which the ceramic body is subjected to the bending moment.

### TECHNOLOGICAL FIELD

An example embodiment relates generally to a ceramic refractory insulation block for a hot press and, more particularly, to a ceramic refractory insulation block including a plurality of reinforcing rods.

### BACKGROUND

During the fabrication of various parts, such as aircraft parts or parts for other applications, a hot press, such as a hot forming press or a superplastic forming press, may be utilized to heat and form the parts. In order to maintain an elevated temperature within the hot press, a hot press may include a plurality of ceramic refractory insulation blocks. For example, ceramic refractory insulation blocks may be utilized to support and insulate the platens which, in turn, support and heat the forming dies. In addition, ceramic refractory insulation blocks may be utilized in the heat shield of a hot press or for other purposes within the hot press.

Over the course of time, the ceramic refractory insulation blocks may crack. With continued usage of the hot press including the ceramic refractory insulation blocks, the cracks may propagate such that the integrity of the ceramic refractory insulation blocks is compromised. In some instances, a ceramic refractory insulation block may crumble or otherwise separate into pieces, thereby reducing both its structural integrity and its insulation properties. As such, the ceramic refractory insulation blocks must generally be replaced during the operational life of a hot press, thereby significantly increasing the operational cost of the hot press and reducing the availability of the hot press since the ceramic refractory insulation blocks are relatively expensive and their replacement is a time consuming process.

The cracking of ceramic refractory insulation blocks and the resulting loss in structural integrity may create other issues within the hot press. With respect to the ceramic refractory insulation blocks that support the platens, the cracking of the ceramic refractory insulation blocks and the resulting loss in structural integrity may allow the platens to bend or otherwise be deformed so as to no longer be flat. The platens are generally expensive as the result of the platens having been custom cast from an exotic material, such as a corrosion-resistant steel (CRES) alloy, that is relatively difficult to machine and to gun drill in order to form the long, lengthwise extending holes for receiving the electric heater rods. Additionally, the platens may be difficult to replace such that the loss of support for the platens as a result of the cracking of the ceramic refractory insulation blocks and the resulting bending of the platens may create substantial financial losses and down time in order to replace the platens that have bent due to the reduction in structural integrity of the ceramic refractory insulation blocks.

### BRIEF SUMMARY

A ceramic refractory insulation block for a hot press is provided. The ceramic refractory insulation block is reinforced in a manner that reduces the likelihood of cracking and, once cracked, reduces the rate at which the crack will propagate through the ceramic refractory insulation block. Thus, the ceramic refractory insulation blocks of an example embodiment may have a longer lifetime and may correspondingly permit other furnace components, such as the platens, to have a longer lifetime. As such, a hot press employing the ceramic refractory insulation blocks of an example embodiment may undergo fewer repairs and may, instead, remain operational for a longer period of time, thereby reducing the costs incurred for the replacement of ceramic refractory insulation blocks or other furnace components and correspondingly reducing the downtime of the hot press employing the ceramic refractory insulation blocks.

In an example embodiment, a ceramic refractory insulation block for a hot press is provided that includes a ceramic body, such as a hot press platen assembly or a heat shield, defining a plurality of outer surfaces. Each of the surfaces is a planar surface. The ceramic body also defines a centerline about which the ceramic body is subjected to a bending moment. The ceramic refractory insulation body of this example embodiment also includes a plurality of reinforcing rods extending through the ceramic body. The reinforcing rods have a greater flexural strength than the ceramic body. One or more of the plurality of reinforcing rods extend through the ceramic body on each of the opposed sides of the centerline about which the ceramic body is subjected to the bending moment.

The one or more reinforcing rods that extend through the ceramic body on one side of the centerline may have an equal spacing from the centerline as one or more corresponding reinforcing rods that extend through the ceramic body on an opposite side of the centerline. In an example embodiment, the plurality of reinforcing rods is disposed in an array that includes at least one row of reinforcing rods. In this embodiment, the adjacent reinforcing rods of a respective row may be spaced apart by 15 to 25 times a diameter of the reinforcing rods. The array may include first and second rows that each includes a plurality of reinforcing rods. In this embodiment, the reinforcing rods of the first row are orthogonal to the reinforcing rods of the second row with the first and second rows being spaced apart by 5 to 25 times a diameter of the reinforcing rods.

In an example embodiment, the outer surfaces of the ceramic body include first and second outer surfaces and the ceramic body defines a central plane at a midpoint between the first and second outer surfaces. In one embodiment in which the array includes at least first and second rows that each include a plurality of reinforcing rods, the reinforcing rods of the first row are positioned a predefined distance from the central plane in one direction and the second row of reinforcing rods is positioned the predefined distance from the central plane in another, opposite direction. In another embodiment, at least one row of reinforcing rods is positioned within the central plane.

In another example embodiment, a hot press is provided that includes a press frame and first and second platens carried by the press frame. The hot press also includes first and second forming dies supported by the upper and lower platens, respectively, with the first and second forming dies defining a die cavity configured to form a part. The hot press of this example embodiment also includes a ceramic refractory insulation block carried by the press frame. The ceramic refractory insulation block includes a ceramic body defining a plurality of planar outer surfaces and a centerline about which the ceramic body is subjected to a bending moment. The ceramic refractory insulation block also includes a plurality of reinforcing rods extending through the ceramic body. The reinforcing rods have a greater flexural strength than the ceramic body. One or more of the reinforcing rods extend through the ceramic body on each of the opposed sides of the centerline about which the ceramic body is subjected to the bending moment.

The hot press may also include a hot press platen assembly that includes one of the first and second platens and one or more ceramic refractory insulation blocks. Additionally or alternatively, the hot press may include a heat shield that includes one or more ceramic refractory insulation blocks.

The plurality of reinforcing rods may be disposed in an array that includes at least one row of reinforcing rods. Adjacent reinforcing rods of a respective row may be spaced apart by 15 to 25 times a diameter of the reinforcing rods. The array of an example embodiment may include at least first and second rows that each includes a plurality of reinforcing rods. In this example embodiment, the reinforcing rods of the first row are orthogonal to the reinforcing rods of the second row with the first and second rows being spaced apart by 5 to 25 times a diameter of the reinforcing rods. In an example embodiment, the one or more reinforcing rods that extend through the ceramic body on one side of the centerline have an equal spacing from the centerline as one or more corresponding reinforcing rods that extend through the ceramic body on an opposite side of the centerline.

The outer surfaces of the ceramic body may include first and second outer surfaces and the ceramic body defines a central plane at a midpoint between the first and second outer surfaces. In one embodiment in which the array includes at least first and second rows that each include a plurality of reinforcing rods, the reinforcing rods of the first row are positioned a predefined distance from the central plane in one direction and the second row of reinforcing rods is positioned the predefined distance from the central plane in another, opposite direction. In another embodiment, at least one row of reinforcing rods is positioned within the central plane.

In a further example embodiment, a method for forming a part is provided that includes heating first and second forming dies supported by first and second platens, respectively, carried by a press frame of a hot press. The method also includes forming the part within a die cavity defined by the first and second forming dies while the first and second forming dies are heated. Further, the method includes insulating at least a portion of the hot press with one or more ceramic refractory insulation blocks. Each ceramic refractory insulation block includes a ceramic body that defines a plurality of planar outer surfaces and a centerline about which the ceramic body is subjected to a bending moment. Each ceramic refractory insulation block also includes a plurality of reinforcing rods extending through the ceramic body. The reinforcing rods have a greater flexural strength than the ceramic body. one or more of the plurality of reinforcing rods extend through the ceramic body on each of the opposite sides of the centerline about which the ceramic body is subjected to the bending moment.

The plurality of reinforcing rods of an example embodiment are disposed in an array that includes at least one row of reinforcing rods. Adjacent reinforcing rods in a respective row may be spaced apart by 15 to 25 times the diameter of the reinforcing rods. The array of an example embodiment includes first and second rows that each include a plurality of reinforcing rods. In this embodiment, the reinforcing rods of the first row are orthogonal to the reinforcing rods of the second row with the first and second rows being spaced apart by 5 to 25 times a diameter of the reinforcing rods.

### BRIEF DESCRIPTION OF THE DRAWINGS

Having thus described aspects of the present disclosure in general terms, reference will now be made to the accompanying drawings, which are not necessarily drawn to scale, and wherein:

FIG. 1 is a perspective view of a hot press, such as a hot forming press or a superplastic forming press, that includes a heat shield that makes use of ceramic refractory insulation blocks in accordance with an example embodiment of the present disclosure;

FIG. 2 is a perspective view of the hot press of FIG. 1 in which the heat shield has been removed to show other ceramic refractory insulation platen blocks in accordance with an example embodiment of the present disclosure;

FIG. 3 is a cross sectional view of a portion of a hot press including a plurality of ceramic refractory insulation blocks in accordance with an example embodiment of the present disclosure;

FIG. 4 is a perspective view of a ceramic refractory insulation block that depicts an array of reinforcing rods disposed in a plurality of rows in accordance with an example embodiment of the present disclosure;

FIG. 5 is a perspective view of a ceramic refractory insulation block that includes an array of reinforcing rods and that illustrates the centerline of the ceramic body about which the ceramic body is subjected to a bending moment that is at least partially countered by the plurality of reinforcing rods in accordance with an example embodiment of the present disclosure;

FIG. 6 is a cross-sectional view of the ceramic refractory insulation block of FIG. 5 taken along line 6-6; and

FIG. 7 is a perspective view of a containment form utilized in order to fabricate a ceramic refractory insulation block in accordance with an example embodiment of the present disclosure.

### DETAILED DESCRIPTION

The present disclosure now will be described more fully hereinafter with reference to the accompanying drawings, in which some, but not all aspects are shown. Indeed, the disclosure may be embodied in many different forms and should not be construed as limited to the aspects set forth herein. Rather, these aspects are provided so that this disclosure will satisfy applicable legal requirements. Like numbers refer to like elements throughout.

A ceramic refractory insulation block for a hot press, such as a hot forming press or a superplastic forming press, is disclosed. The ceramic refractory insulation block is reinforced so as to reduce the likelihood of cracking and, in the event of the initiation of a crack, to reduce the likelihood of crack propagation and/or the rate at which the crack propagates. As such, the ceramic refractory insulation block may maintain its structural integrity for a longer period of time, thereby reducing the instances in which the hot press must be taken offline and the ceramic refractory insulation blocks replaced. Additionally, by maintaining the structural integrity of the ceramic refractory insulation blocks, damage to other components of the hot press, such as the platens, may be reduced, thereby further reducing the cost and downtime associated with the repair of these other components of the hot press.

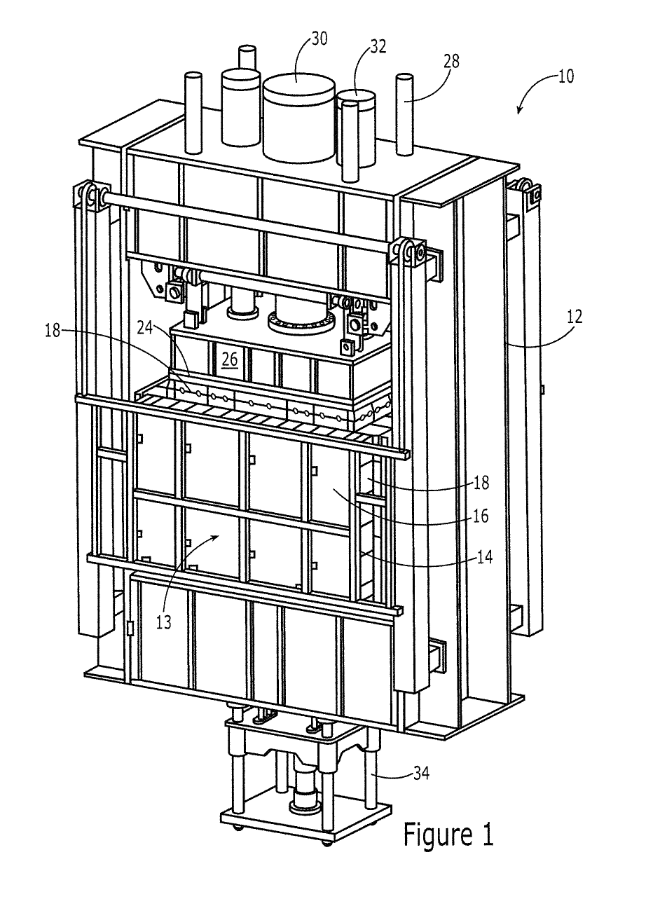

Ceramic refractory insulation blocks may be employed throughout a hot press in a variety of different locations. As shown in FIG. 1, one example of a hot press 10, such as a hot forming press or a superplastic forming press, is depicted. The hot press includes a press frame 12. In order to provide insulation to an internal cavity defined by the press frame in which the part is formed, the hot press may include a heat shield 13 mounted to the press frame. Although the heat shield may be constructed in various manners, the heat shield of an example embodiment may include a frame 14 formed of a CRES alloy and sheet metal 16 covering the frame. Within the frame, the heat shield may include one or more ceramic refractory insulation blocks 18 facing the internal cavity within which the part is formed. The ceramic refractory insulation blocks serve to insulate the hot press and to maintain the temperature within the internal cavity during hot forming or superplastic forming operations which are conducted at elevated temperatures, such as 700° F. to 1700° F. As described below, ceramic refractory insulation blocks may also be used in other locations throughout the hot press.

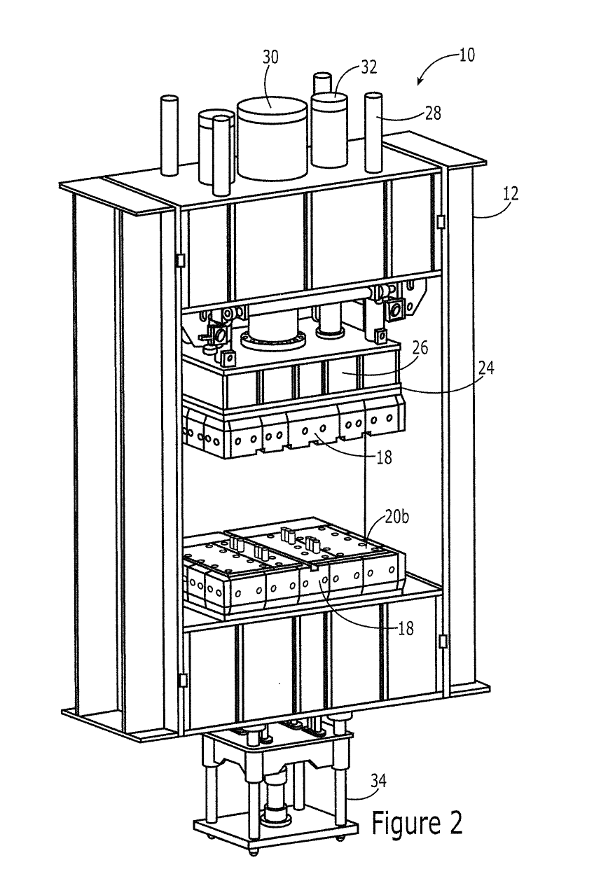

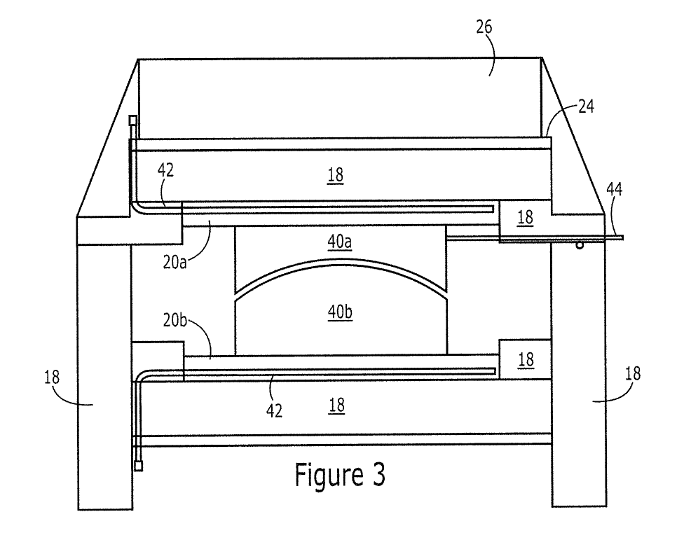

As shown in FIG. 2, the hot press 10 of FIG. 1 is depicted with the heat shield having been removed for purposes of illustration. The hot press defines an internal cavity within which the dies for forming the part may be disposed. The dies are supported by platens, such as an upper platen 20a and a lower platen 20b as shown in FIG. 3 for a hot press having the orientation depicted in FIGS. 1 and 2. The platens may be fabricated from, for example, CRES alloys. In order to provide insulation for the platens and the forming dies, the hot press may also include one or more ceramic refractory insulation blocks 18 that, in combination with a respective platen, comprise a hot press platen assembly. Thus, an upper hot press platen assembly may include the upper platen and one or more ceramic refractory insulation blocks that surround the upper platen. Similarly, a lower hot press platen assembly may include the lower platen and one or more ceramic refractory insulation blocks that surround the lower platen. The ceramic refractory insulation blocks that comprise a hot press platen assembly are positioned adjacent to and partially surround the respective platen. In this regard, the ceramic refractory insulation blocks of a hot press platen assembly may be positioned about the edge portions of a respective platen so as to insulate the platen. The ceramic refractory insulation blocks of a hot press assembly may also be positioned across the rear surface of the respective platen, that is, the surface of the respective platen opposite the internal cavity in which the part is formed.

As shown in FIGS. 1 and 2, the hot press 10 of the illustrated embodiment may also include a cooling plate 24 and a bolster plate 26 to support and cool the upper platen 20a (as shown in FIG. 3). Further, the hot press may include one or more alignment guides 28 that maintain the platens and, in turn, the forming dies carried by the platens in alignment within the press frame 12 as the platens are moved relative to one another. With respect to the hot press of FIGS. 1 and 2, the upper platen 20a may be raised and lowered relative to the lower platen 20b. In the illustrated embodiment, the hot press includes a first hydraulic cylinder 30 configured to apply a pressing force urging the first and second platens toward one another and a second, smaller hydraulic cylinder 32 configured to raise and lower the upper platen. The hot press of the illustrated embodiment may also include a die cushion assembly 34.

Referring now to FIG. 3, a cross-sectional view of a portion of the hot press 10 depicting a plurality of ceramic refractory insulation blocks 18 is shown. In the illustrated embodiment, upper and lower platens 20a, 20b support upper and lower forming dies 40a, 40b, respectively, which serve to define and form the part. In this regard, the forming dies generally cooperate to define a die cavity in which a workpiece is placed and thereafter formed into a part having a shape as defined by the die cavity. In the illustrated embodiment, for example, the hot press may include a gas line 44 that injects a gas into the die cavity that may serve to facilitate forming of the part, such as in conjunction with a superplastic forming operation. As also shown in FIG. 3, the upper and lower platens may be heated which, in turn, may heat the upper and lower forming dies and the part formed between the two die halves. While the upper and lower platens may be heated in various manners, the upper and lower platens of an example embodiment may include electric heater rods 42 disposed within lengthwise extending passageways defined by the respective platens.

As described above, the hot press 10 may include a hot press platen assembly that includes the upper platen 20a and a plurality of ceramic refractory insulation blocks 18 that surround the upper platen, and a hot press platen assembly that includes the lower platen 20b and a plurality of ceramic refractory insulation blocks that surround the lower platen. The ceramic refractory insulation blocks of a hot press platen assembly may be positioned proximate the rear surface of a respective platen, that is, proximate the surface of the respective platen that is opposite the surface that faces into the internal cavity of the hot press. In order to insulate a platen, ceramic refractory insulation blocks of a hot press platen assembly may also be positioned about the edges of the respective platen. The ceramic refractory insulation blocks 18 may also be included within the heat shield 13 of the hot press, such as the front and rear heat shield of the hot press. Ceramic refractory insulation blocks may also comprise other furnace components, such as door seals.

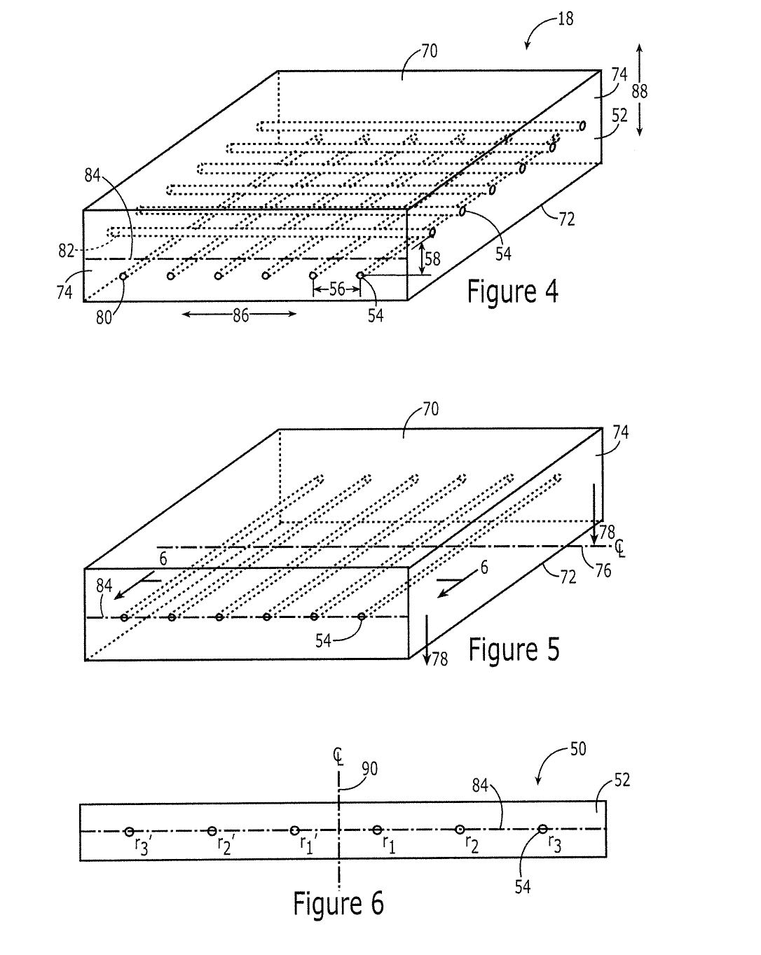

As shown in FIGS. 4-6, a ceramic refractory insulation block 18 of an example embodiment includes a ceramic body 52 that may be formed of a cast silica/calcium aluminate or mullite based ceramic material. Unlike the forming dies 40 that frequently define a cavity having a complex contour in order to appropriately shape the part to be formed, the ceramic body of a ceramic refractory insulation block may include a plurality of outer surfaces that are each planar surfaces. As shown in FIGS. 4-6, for example, the ceramic body may include an upper planar surface 70 and a lower planar surface 72 and a plurality, e.g., four, side surfaces 74 that are also planar. As shown in FIG. 5, the ceramic body 52 may also define a centerline 76 about which the ceramic body is subjected to a bending moment as indicated by the downwardly extending arrows 78, such as due to the weight of the ceramic body itself and the forces to which the ceramic body is subjected during operation of the hot press 10. A ceramic refractory insulation block may have various sizes, but in one embodiment, has a thickness of between about 4 and 18 inches, such as about 10 inches.

The ceramic refractory insulation block 18 of an example embodiment also includes a plurality of reinforcing rods 54 extending through the ceramic body 52. The reinforcing rods have a greater flexural strength than the ceramic body, such as, for example, a flexural strength that is approximately five times the flexural strength of the ceramic body. For example, reinforcing rods formed of quartz may have a flexural strength of about 10,000 psi, while reinforcing rods formed of alumina may have a flexural strength of 56,000 psi. Thus, the reinforcing rods support the ceramic body and maintain the structural integrity of the ceramic refractory insulation block. Although formed of different materials, the reinforcing rods and the ceramic body of an example embodiment are formed of respective materials that have the same or approximately the same coefficient of thermal expansion. In an example embodiment, the plurality of reinforcing rods are formed of monolithic fused oxides of silica or aluminum that are cast into the ceramic body. The rods may be cast into the ceramic body so as to be bonded securely. For example, the reinforcing rods may be textured or profiled to improve the bond with the ceramic body. Alternatively, the reinforcing rods may be coated with a release agent to prevent bonding of the reinforcing rods to the ceramic body such that the reinforcing rods may thereafter translate axially relative to the ceramic body, such as to prevent cracking during drying and curing of the ceramic refractory insulation block. The reinforcing rods may have a diameter of between about ½ inch and 2 inch and may extend across the full length and width of the ceramic body. Although the reinforcing rods may be solid lengthwise extending rods, one or more of the reinforcing rods may be hollow so as to receive an electrical heater element within a cavity defined by the hollow opening for heating the upper and lower platens 20a, 20b and the upper and lower forming dies 40a, 40b.

As shown in FIGS. 4-6, the plurality of reinforcing rods 54 may be disposed in an array. In this regard, the array of reinforcing rods may include at least one and, in some instances, a plurality of rows of reinforcing rods. For example, the ceramic refractory insulation block 18 of FIG. 4 includes two rows of reinforcing rods designated row 80 and row 82. The rows of reinforcing rods may be offset from a central plane 84 of the ceramic refractory insulation block 18 by an equal distance, but in opposite directions. In this regard, the ceramic refractory insulation block may define a central plane at the midpoint between a pair of opposed outer surfaces, e.g., the midpoint of first and second outer surfaces, such as at the midpoint between the upper and lower surfaces 70, 72. As such, one row 80 of reinforcing rods may be positioned a predefined distance from the central plane in one direction, such as in a direction so as to be closer to the lower surface, and a second row 82 of reinforcing rods may be positioned the same predefined distance from the central plane, but in another, opposite direction, such as in a direction so as to be closer to the upper surface. Additionally, the rows of reinforcing rods may be oriented orthogonal to one another, as described below. Although a ceramic refractory insulation block 18 that includes two rows is illustrated and described herein, the ceramic refractory insulation block may include a plurality of rows of reinforcing rods, such as an even number of rows of reinforcing rods with half of the rows spaced from one another in one direction from the central plane and the other half of the rows spaced from one another in the opposite direction from the central plane.

Within a row 80, 82, a plurality of reinforcing rods 54 may be spaced apart from one another in a first direction, while the rows may be spaced apart from one another in a second direction, perpendicular to the first direction. In the embodiment depicted in FIG. 4, for example, each row includes a plurality of reinforcing rods spaced apart from one another in a horizontal direction 86 with the rows being spaced apart from one another in a vertical direction 88. However, the rows of reinforcing rods of an array may be disposed in other orientations in other embodiments. In addition, the reinforcing rods of adjacent rows may be disposed orthogonal to one another. For example, the reinforcing rods of the top and bottom rows of the ceramic refractory insulation block of FIG. 4 are orthogonal to the reinforcing rods of the middle row.

As shown in FIGS. 5 and 6, the plurality of reinforcing rods 54 extend through the ceramic body 52 such that one or more of the plurality of reinforcing rods extend across and are disposed on each of the opposed sides of the centerline 76 about which the ceramic body is subjected to a bending moment 78. In this regard, the plurality of reinforcing rods may be oriented to extend continuously from one side of the centerline 76 to the opposite side of the centerline as shown in FIG. 5, thereby supporting the ceramic body when subjected to the bending moment about the centerline. As such, the plurality of reinforcing rods provide structural support for the ceramic body by increasing the modulus of rupture as the ceramic body is subjected to a bending moment about the centerline 76.

Additionally, when viewed along the length of reinforcing rods 54 as shown in cross-section in FIG. 6, the plurality of reinforcing rods may be disposed in a symmetrical relationship relative to a centerline 90, perpendicular to the centerline 76 in this example embodiment in which the ceramic body 52 is a rectangular solid. In this embodiment in which the reinforcing rods define a lengthwise direction, centerline 90 may be considered a lengthwise centerline, while centerline 76 may be considered a widthwise centerline, perpendicular to the lengthwise centerline. By positioning the reinforcing rods in a symmetrical relationship relative to the lengthwise centerline 90, the reinforcing rods that extend through the ceramic body on one side of the centerline 90 have an equal spacing from the centerline 90 as corresponding reinforcing rods that extend through the ceramic body on the opposite side of the centerline. With reference to FIG. 6, the plurality of reinforcing rods of a first row may be disposed such that each rod on one side of the centerline 90 has a corresponding rod on the other side of the centerline 90 that is spaced from the centerline 90 in the opposite direction, but by an equal amount. For example, reinforcing rods r₁ and r₁′ are spaced from the centerline 90 by equal amounts in opposite directions. Similarly, reinforcing rods r₂ and r₂′ and reinforcing rods r₃ and r₃′ are spaced from the centerline 90 by equal amounts in opposite directions.

In the embodiment of FIGS. 5 and 6, the ceramic refractory insulation block 18 includes a single row of reinforcing rods 54 positioned along a central plane 84 of the ceramic body 52 defined at the midpoint between first and second outer surfaces, such as the upper and lower surfaces 70, 72, of the ceramic body. While the illustrated embodiment depicts a single row of reinforcing rods, the ceramic refractory insulation block may include a plurality of rows of reinforcing rods, such as an odd number of rows of reinforcing rods with one row of reinforcing rods located in the central plane and with half of the remaining rows spaced from one another in one direction from the central plane and the other half of the remaining rows spaced from one another in the opposite direction from the central plane.

In embodiments in which the ceramic body 52 has planar outer surfaces 70, 72 and is intended to provide support, such as to provide support for a platen, such as the upper platen 20a or the lower platen 20b, across its planar rear surface, the ceramic refractory insulating block may not be subjected to side wall forming stresses to the same degree as experienced by a forming die, such as upper forming die 40a or lower forming die 40b, that defines a cavity for forming a part having a complex contour. As such, the reinforcing rods 54 may be spaced relatively far apart from one another while still providing sufficient strength to the ceramic body in order to resist both cracking and crack propagation. In this regard, the reinforcing rods of a respective row 80, 82 may be disposed with the ceramic body so as to extend parallel to one another and to be spaced apart by an equal amount. In this regard, adjacent reinforcing rods of a respective row may be spaced apart, such as based upon a center-to-center spacing, of 15 to 25 times the diameter of the reinforcing rods, as indicated by designation 56 in FIG. 4. In addition, the rows of the array of reinforcing rods may be spaced apart from one another by 5 to 25 times the diameter of the reinforcing rods, as indicated by designation 58 in FIG. 4. By spacing the reinforcing rods in the foregoing manner, the reinforcing rods may provide ample support for the ceramic body so as to resist the initiation and propagation of cracks while permitting the ceramic refractory insulation block to include a greater percentage of the ceramic body which, in turn, increases the insulative properties of the ceramic refractory insulation block 18.

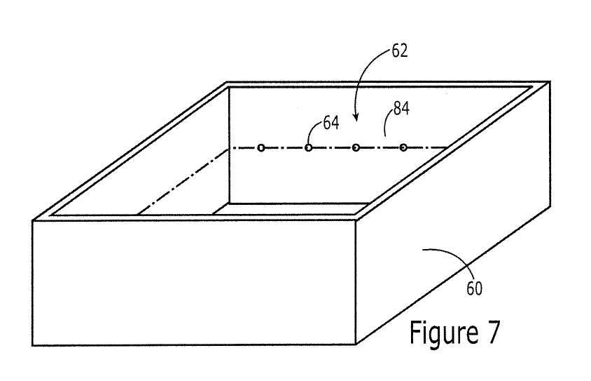

In order to form a ceramic refractory insulation block 18, a containment form 60 may be provided as shown in FIG. 7 that defines an internal cavity 62 having a size and shape of the resulting ceramic refractory insulation block. The reinforcing rods 54 may then be placed into the containment box in the same relative locations that will be maintained by the reinforcing rods within the resulting ceramic refractory insulation block. In one embodiment, holes 64 may be formed, such as by being drilled into or through the sidewalls of the containment form at the respective locations of the reinforcing rods. The reinforcing rods may then be placed within the containment box with the ends of the reinforcing rods disposed within respective holes. The reinforcing rods may be secured with respect to the containment form. In an example embodiment, the ends of the reinforcing rods are snugly maintained within the holes by a sealant, such as a rubber gasket or a sealing compound, e.g., Hydro-Cal cement, that fills the holes around the ends of the reinforcing rods. The ceramic material, such as a cast silica/calcium aluminate or mullite based ceramic material, may then be poured into the containment form and subjected to air drying, such as for one to two days. The ceramic refractory insulation block may then be demolded from the containment form and air cooled for three to ten days prior to subjecting the ceramic refractory insulation block to curing in a furnace and a sintering heat treatment. Opposed surfaces, such as the top and bottom surfaces, of the ceramic body 52 may then be ground so as to be flat and to be parallel with one another prior to being installed in a hot press 10.

As described above, a ceramic refractory insulation block 18 for a hot press 10 is provided that is reinforced in a manner that reduces the likelihood of cracking and, once cracked, reduces the rate at which the crack will propagate through the ceramic refractory insulation block. Thus, the ceramic refractory insulation blocks of an example embodiment may have a longer lifetime and may correspondingly permit other furnace components, such as the upper and lower platens 20a, 20b, to have a longer lifetime. As such, a hot press employing the ceramic refractory insulation blocks of an example embodiment may undergo fewer repairs and may, instead, remain operational for a longer period of time, thereby reducing the costs incurred for the replacement of ceramic refractory insulation blocks or other furnace components and correspondingly reducing the downtime of the hot press employing the ceramic refractory insulation blocks.

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

That which is claimed:

1. A ceramic refractory insulation block for a hot press, the ceramic refractory insulation block comprising:
a ceramic body defining a plurality of outer surfaces, wherein each outer surface is a planar surface, wherein the ceramic body also defines a centerline about which the ceramic body is subjected to a bending moment; and
a plurality of reinforcing rods extending through the ceramic body, wherein the reinforcing rods have a greater flexural strength than the ceramic body, and wherein one or more of the plurality of reinforcing rods extend through the ceramic body on each of the opposed sides of the centerline about which the ceramic body is subjected to the bending moment.

2. A ceramic refractory insulation block according to claim 1 wherein the one or more reinforcing rods that extend through the ceramic body on one side of the centerline have an equal spacing from the centerline as one or more corresponding reinforcing rods that extend through the ceramic body on an opposite side of the centerline.

3. A ceramic refractory insulation block according to claim 1 wherein the plurality of reinforcing rods are disposed in an array comprising at least one row of reinforcing rods.

4. A ceramic refractory insulation block according to claim 3 wherein adjacent reinforcing rods of a respective row are spaced apart by 15 to 25 times a diameter of the reinforcing rods.

5. A ceramic refractory insulation block according to claim 3 wherein the array comprises at least first and second rows that each comprise a plurality of reinforcing rods, and wherein the reinforcing rods of the first row are orthogonal to the reinforcing rods of the second row with the first and second rows being spaced apart by 5 to 25 times a diameter of the reinforcing rods.

6. A ceramic refractory insulation block according to claim 3 wherein the outer surfaces of the ceramic body comprise first and second outer surfaces and the ceramic body defines a central plane at a midpoint between the first and second outer surfaces, wherein the array comprises at least first and second rows that each comprise a plurality of reinforcing rods, and wherein the reinforcing rods of the first row positioned a predefined distance from the central plane in one direction and the second row of reinforcing rods is positioned the predefined distance from the central plane in another, opposite direction.

7. A ceramic refractory insulation block according to claim 3 wherein the outer surfaces of the ceramic body comprise first and second outer surfaces and the ceramic body defines a central plane at a midpoint between the first and second outer surfaces, wherein at least one row of reinforcing rods is positioned within the central plane.

8. A hot press comprising:
a press frame;
first and second platens carried by the press frame;
first and second forming dies supported by the upper and lower platens, respectively, wherein the first and second forming dies define a die cavity configured to form a part; and
a ceramic refractory insulation block carried by the press frame, wherein the ceramic refractory insulation block comprises a ceramic body defining a plurality of planar outer surfaces and a centerline about which the ceramic body is subjected to a bending moment and a plurality of reinforcing rods extending through the ceramic body, wherein the reinforcing rods have a greater flexural strength than the ceramic body, and wherein one or more of the plurality of reinforcing rods extend through the ceramic body on each of the opposed sides of the centerline about which the ceramic body is subjected to the bending moment.

9. A hot press according to claim 8 wherein the plurality of reinforcing rods of a ceramic refractory insulation block are disposed in an array comprising at least one row of reinforcing rods.

10. A hot press according to claim 9 wherein adjacent reinforcing rods of a respective row are spaced apart by 15 to 25 times a diameter of the reinforcing rods.

11. A hot press according to claim 9 wherein the array comprises at least first and second rows that each comprise a plurality of reinforcing rods, and wherein the reinforcing rods of the first row are orthogonal to the reinforcing rods of the second row with the first and second rows being spaced apart by 5 to 25 times a diameter of the reinforcing rods.

12. A hot press according to claim 9 wherein the outer surfaces of the ceramic body comprise first and second outer surfaces and the ceramic body defines a central plane at a midpoint between the first and second outer surfaces, wherein the array comprises at least first and second rows that each comprise a plurality of reinforcing rods, and wherein the reinforcing rods of the first row positioned a predefined distance from the central plane in one direction and the second row of reinforcing rods is positioned the predefined distance from the central plane in another, opposite direction.

13. A hot press according to claim 9 wherein the outer surfaces of the ceramic body comprise first and second outer surfaces and the ceramic body defines a central plane at a midpoint between the first and second outer surfaces, wherein at least one row of reinforcing rods is positioned within the central plane.

14. A hot press according to claim 8 further comprising a hot press platen assembly comprising one of the first and second platens and one or more ceramic refractory insulation blocks.

15. A hot press according to claim 8 wherein the press frame comprises a heat shield, and wherein the heat shield comprises one or more ceramic refractory insulation blocks.

16. A hot press according to claim 8 wherein the one or more reinforcing rods that extend through the ceramic body on one side of the centerline have an equal spacing from the centerline as one or more corresponding reinforcing rods that extend through the ceramic body on an opposite side of the centerline.

17. A method for forming a part, the method comprising:
heating first and second forming dies supported by first and second platens carried by a press frame of a hot press;
forming the part within a die cavity defined by the first and second forming dies while the first and second forming dies are heated; and
insulating at least a portion of the hot press with one or more ceramic refractory insulation blocks, wherein each ceramic refractory insulation block comprises a ceramic body defining a plurality of planar outer surfaces and a centerline about which the ceramic body is subjected to a bending moment and a plurality of reinforcing rods extending through the ceramic body, wherein the reinforcing rods have a greater flexural strength than the ceramic body, wherein one or more of the plurality of reinforcing rods extend through the ceramic body on each of the opposed sides of the centerline about which the ceramic body is subjected to the bending moment.

18. A method according to claim 17 wherein the plurality of reinforcing rods are disposed in an array comprising at least one row of reinforcing rods.

19. A method according to claim 18 wherein adjacent reinforcing rods of a respective row are spaced apart by 15 to 25 times a diameter of the reinforcing rods.

20. A method according to claim 18 wherein the array comprises at least first and second rows that each comprise a plurality of reinforcing rods, and wherein the reinforcing rods of the first row are orthogonal to the reinforcing rods of the second row with the first and second rows being spaced apart by 5 to 25 times a diameter of the reinforcing rods.
